(19) United States
(12) Patent Application Publication
(10) Pub. No.: US 2013/0179864 A1
(43) Pub. Date: Jul. 11, 2013

(54) DEADLOCK FREE SYNCHRONIZATION SYNTHESIZER FOR MUST-HAPPEN-BEFORE RELATIONS IN PARALLEL PROGRAMS AND METHOD THEREOF

(71) Applicants: Yi-Shan Lu, Hsinchu (TW); Hsien-Lun Pai, Hsinchu (TW); Meng-Huan Wu, Hsinchu (TW); Ren-Song Tsay, Hsinchu (TW)

(72) Inventors: Yi-Shan Lu, Hsinchu (TW); Hsien-Lun Pai, Hsinchu (TW); Meng-Huan Wu, Hsinchu (TW); Ren-Song Tsay, Hsinchu (TW)

(73) Assignee: NATIONAL TSING HUA UNIVERSITY, Hsinchu (TW)

(21) Appl. No.: 13/455,659

(22) Filed: Apr. 25, 2012

(30) Foreign Application Priority Data
Jan. 10, 2012 (TW) 101100896

(51) Int. Cl. G06F 9/44

(52) U.S. Cl. 717/127

(57) ABSTRACT

A deadlock free synchronization synthesizer for must-happen-before relations in at least two parallel programs or at least two threads each having multiple code segments has an input device to specify a synchronization point to involving code segments for each parallel program or thread and must-happen-before relations to the synchronization point, an analyzing module connected to the input device to detect existence of a deadlock in the parallel programs by using the must-happen-before relations, and a synthesizing module connected to the analyzing module to synthesize a practice code corresponding to the parallel programs if the deadlock existence detection is negative.

### CROSS-REFERENCE TO RELATED APPLICATION

This application claims priority from application No. 101100896, filed on Jan. 10, 2012 in the Taiwan Intellectual Property Office, the entire contents of which are hereby incorporated by reference.

### FIELD OF THE INVENTION

The invention relates to a deadlock free synchronization synthesizer, and more particularly to a deadlock free synchronization synthesizer for must-happen-before relations in parallel programs to detect possible deadlock and synthesize corresponding code to ensure program smooth running and method thereof.

### BACKGROUND OF THE INVENTION

In recent years, programmers often need to adopt synchronization to ensure the atomicity and shared-data dependency between parallel programs in multi-cores or multiple threads. As some program depends heavily on the initiation or finish of another program, a proper synchronization mechanism is necessary to control the execution of a certain program or the entire program is easily in a deadlock situation. Conventional methods to avoid the deadlock situation are complex and complicated.

U.S. Pat. No. 6,898,617 discloses deadlock situations within a computing environment are avoided by properly managing pools of threads used to service requests of the computing environment. When a server of the computing environment receives a request to be processed and that request is waiting on a response from a client of the computing environment, the set of eligible thread pools for the response is dynamically altered. This dynamic altering allows the response to be serviced by a thread pool different from the thread pool servicing the request, thereby avoiding a deadlock situation.

Often, the program easily falls in the trap of a deadlock. In addition, inaccuracy or an action not-so-desired generally leads to the fault of two parallel programs, i.e., the generation of a deadlock. However, even all programmers know the fault, they seem have no acceptable and easy solution to solve the problem.

### SUMMARY OF THE INVENTION

One objective of the invention is to provide deadlock free synchronization synthesizer for much-happen-before relations in parallel programs and the method thereof.

In a preferred embodiment of the present invention, the synchronization synthesizer constructed in accordance with the present invention is aimed to detect a deadlock.

In order to accomplish the aforementioned objective, the synthesizer for must-happen-before relations in parallel programs is used in at least two parallel programs or at least two threads. Each parallel program or thread comprises multiple code segments. The deadlock-free synchronization synthesizer for must-happen-before relations in parallel programs comprises:

an input device specifying a synchronization point for each code segment involved and must-happen-before relations between the synchronization points;

an analyzing module connected to the input device for justifying whether the parallel programs have a deadlock based on the must-happen-before relations; and

a synthesizing module connected to the analyzing module for synthesizing a corresponding synchronization primitive of the parallel programs. That is, should the judgment of a deadlock in the parallel programs by the analyzing module be negative, the synthesizing module synthesizes a corresponding practice code for the parallel programs.

Another objective of the present invention is to provide a method for deadlock detection. The method for deadlock detection is used for at least two parallel programs or at least two threads. Each program or thread includes multiple code segments.

A method for a deadlock-free synthesizer for must-happen-before relations in parallel programs comprises the steps of:

specifying a synchronization point to each code segment of the parallel programs or threads;

specifying must-happen-before relations to the synchronization point;

using the must-happen-before relations of the synchronization point to detect existence of a deadlock;

judging existence of deadlock in the parallel programs; and

synthesizing a practice code corresponding to the parallel programs should the judgment of the existence of deadlock being negative.

### BRIEF DESCRIPTION OF THE DRAWINGS

FIG. 1 is a schematic view showing the system structure of the deadlock free synchronization synthesizer for must-happen-before relations in parallel programs;

FIG. 2 is a flow chart showing the steps applied in the deadlock free method for must-happen-before relations in parallel programs;

FIG. 3 is a flow chart showing the steps applied to detect existence of a deadlock in parallel programs;

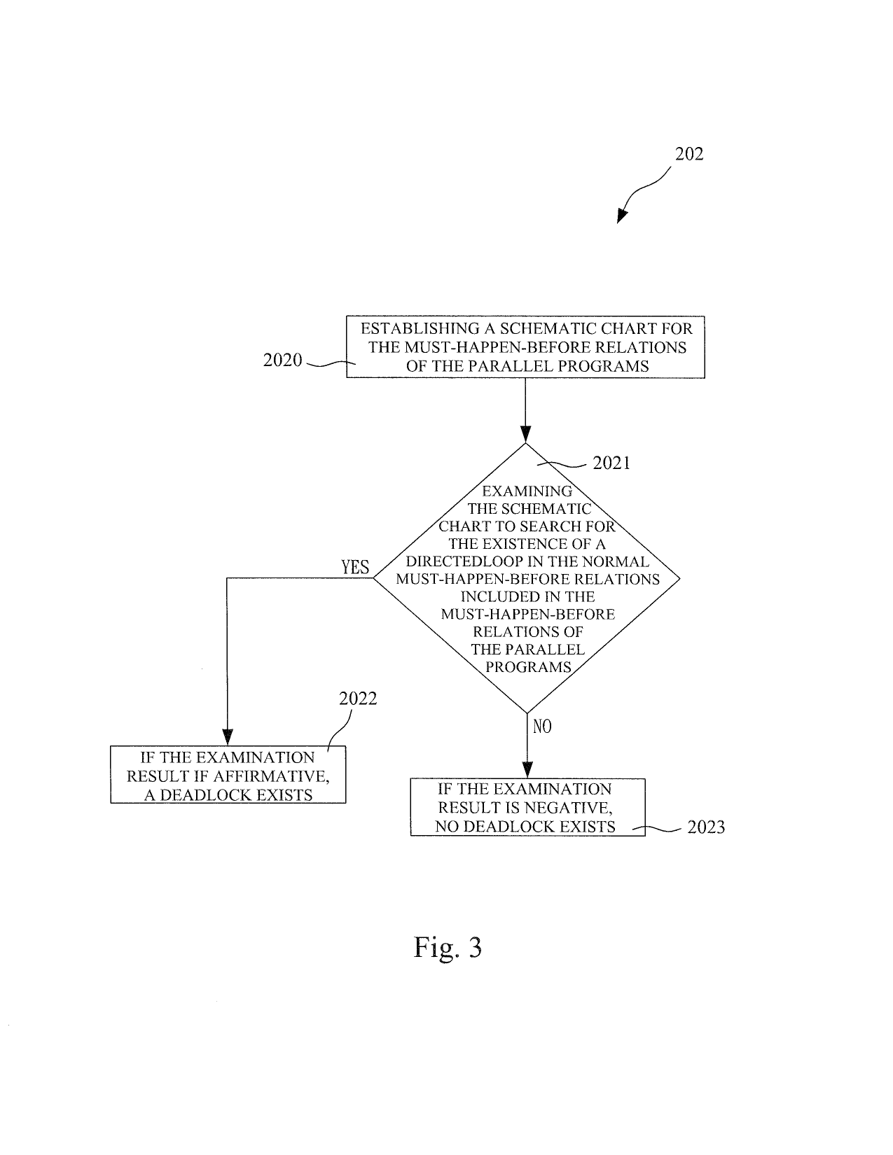

FIG. 4A is a schematic view showing the must-happen-before relations applied in the present invention;

FIG. 4B is a schematic view showing relationships of code segments and time sequence applied in FIG. 4A; and

FIG. 4C is a schematic view showing relationships of code segments and time sequence of loop-backed must-happen-before relations inaccurately indicated as normal must-happen-before relations.

### DETAILED DESCRIPTION OF THE INVENTION

In order to describe details of the preferred embodiment of the present invention, description of the structure, and the application as well as the steps are made with reference to the accompanying drawings. It is learned that after the description, any variation, modification or the like to the structure and the steps of the embodiments of the preferred embodiment of the present invention is easily made available to any person skilled in the art. Thus, the following description is only for illustrative purpose only and does not, in any way, try to limit the scope of the present invention.

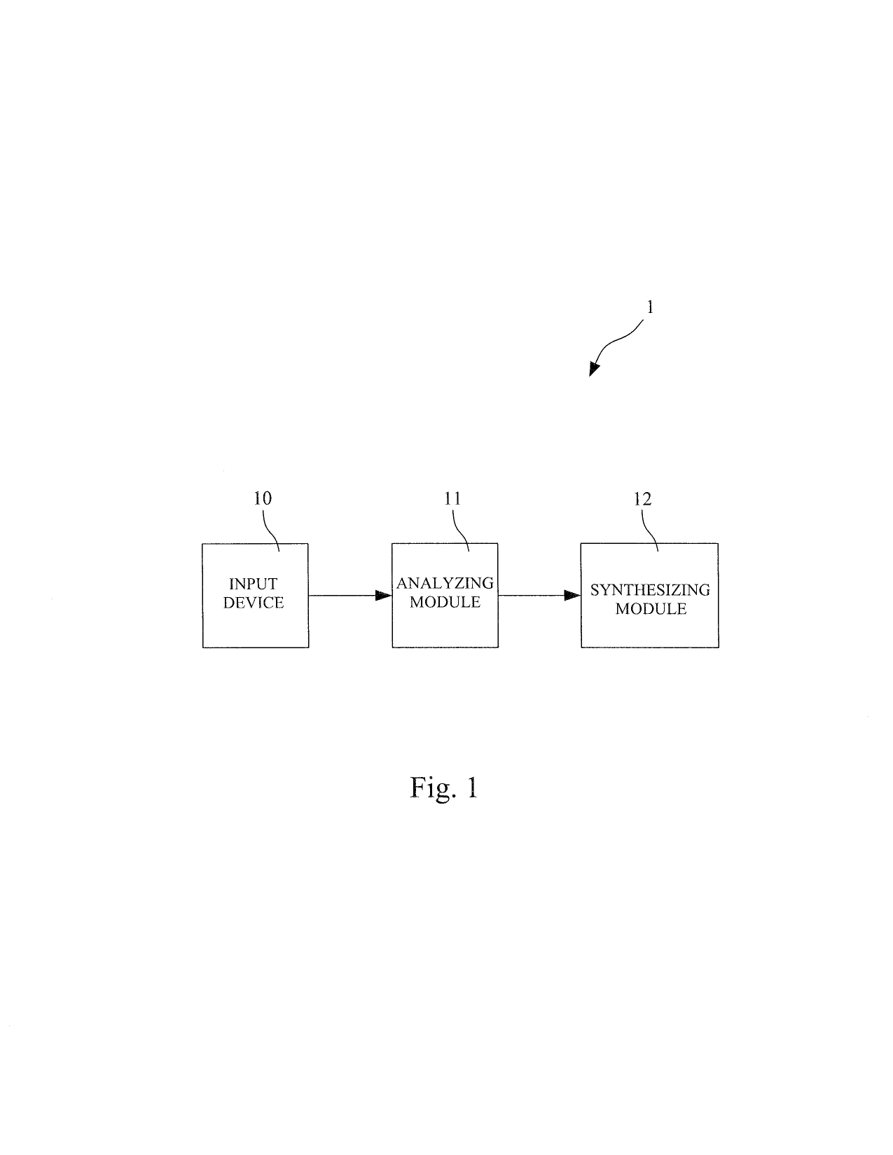

With reference to FIG. 1 of the preferred embodiment of the present invention, it is noted that the deadlock free synchronization synthesizer 1 for must-happen-before relations is used for at least two parallel programs or threads, wherein the at least two parallel programs or threads respectively includes multiple code segments. The deadlock free synchronization synthesizer 1 for must-happen-before relations includes an input device 10, an analyzing module 11 and a synthesizing module 12.

The input device 10 is to specify a synchronization point for each code segment involved and the must-happen-before relations of the synchronization point.

The analyzing module 11 is connected to the input device 10 and uses the must-happen-before relations to detect existence of deadlock in the parallel programs.

The synthesizing module 12 is connected to the analyzing module 11 and responsible for synthesizing the corresponding practice code to the parallel programs when the detection of existence of deadlock by the analyzing module 11 is negative.

In a must-happen-before relation, the code segments which must be executed first during run time are refereed as source code segments, and the other code segments are referred as destination code segments. If the source code segments' first appearance is earlier than those of the destination code segments, the must-happen-before relations of the synchronization points are normal must-happen-before relations. If the source code segments' first appearance is later than those of the destination code segments, the must-happen-before relations of the synchronization points are loop-backed must-happen-before relations.

The analyzing module 11 first establishes a schematic chart for the must-happen-before relations of the parallel programs. Then, the analyzing module 11 examines the schematic chart to search for the existence of a directed loop in the normal must-happen-before relations included in the must-happen-before relations of the parallel programs. If such directed loop in the normal must-happen-before relations exists in the must-happen-before relations of the parallel programs, the judgment of a deadlock is affirmative. If such directed loop in the normal must-happen-before relations does not exist in the must-happen-before relations of the parallel programs, the judgment of the deadlock is negative.

In a preferred embodiment of the present invention, the synthesizing module 12 is a low level basic structure such as APIs provided by portable operating system interface (POSIX) thread library.

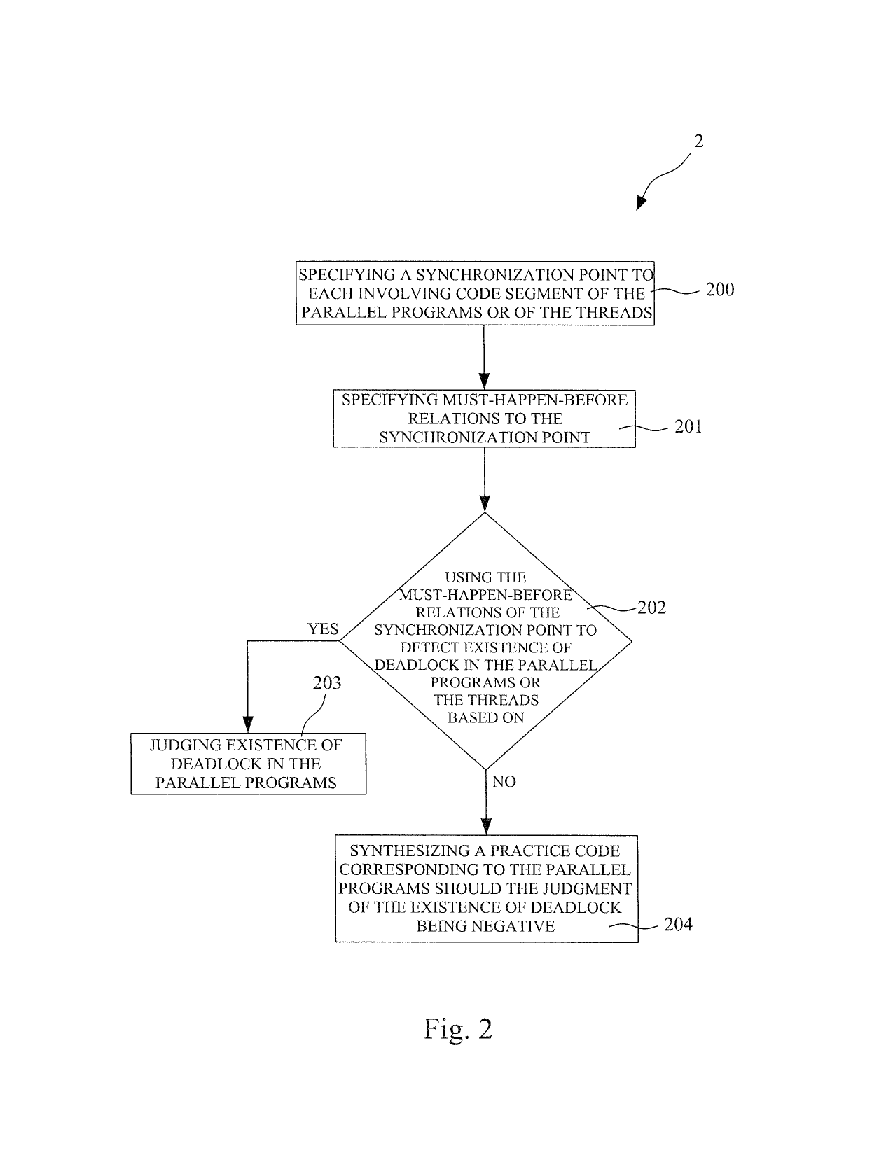

With reference to FIG. 2, the method of the referred embodiment of the present invention is used in at least two parallel programs or at least two threads. Each parallel program or thread includes respectively multiple code segments. The method of the present invention includes the steps of:

200: specifying a synchronization point to each involving code segment of the parallel programs or of the threads;

201: specifying must-happen-before relations to the synchronization point;

202: using the must-happen-before relations of the synchronization point to detect existence of deadlock in each of the parallel programs or threads based on;

203: judging existence of deadlock in the parallel programs; and

204: synthesizing a practice code corresponding to the parallel programs should the judgment of the existence of deadlock being negative.

In a must-happen-before relation, the code segments which must be executed first during run time are refereed as source code segments, and the other code segments are referred as destination code segments.

If the source code segments' first appearance is earlier than those of the destination code segments, the must-happen-before relations of the synchronization points are normal must-happen-before relations. If the source code segments' first appearance is later than those of the destination code segments, the must-happen-before relations of the synchronization points are loop-backed must-happen-before relations.

In step 202, there are further steps including:

2020: establishing a schematic chart for the must-happen-before relations of the parallel programs;

2021: examining the schematic chart to search for the existence of a directed loop in the normal must-happen-before relations included in the must-happen-before relations of the parallel programs;

2022: if the examination result if affirmative, a deadlock exists; and

2023: if the examination result is negative, no deadlock exists.

In a preferred embodiment of the present invention, a low level synchronization basic structure, such as APIs provided by portable operation system interface (POSIX) thread library, is used to complete step 204.

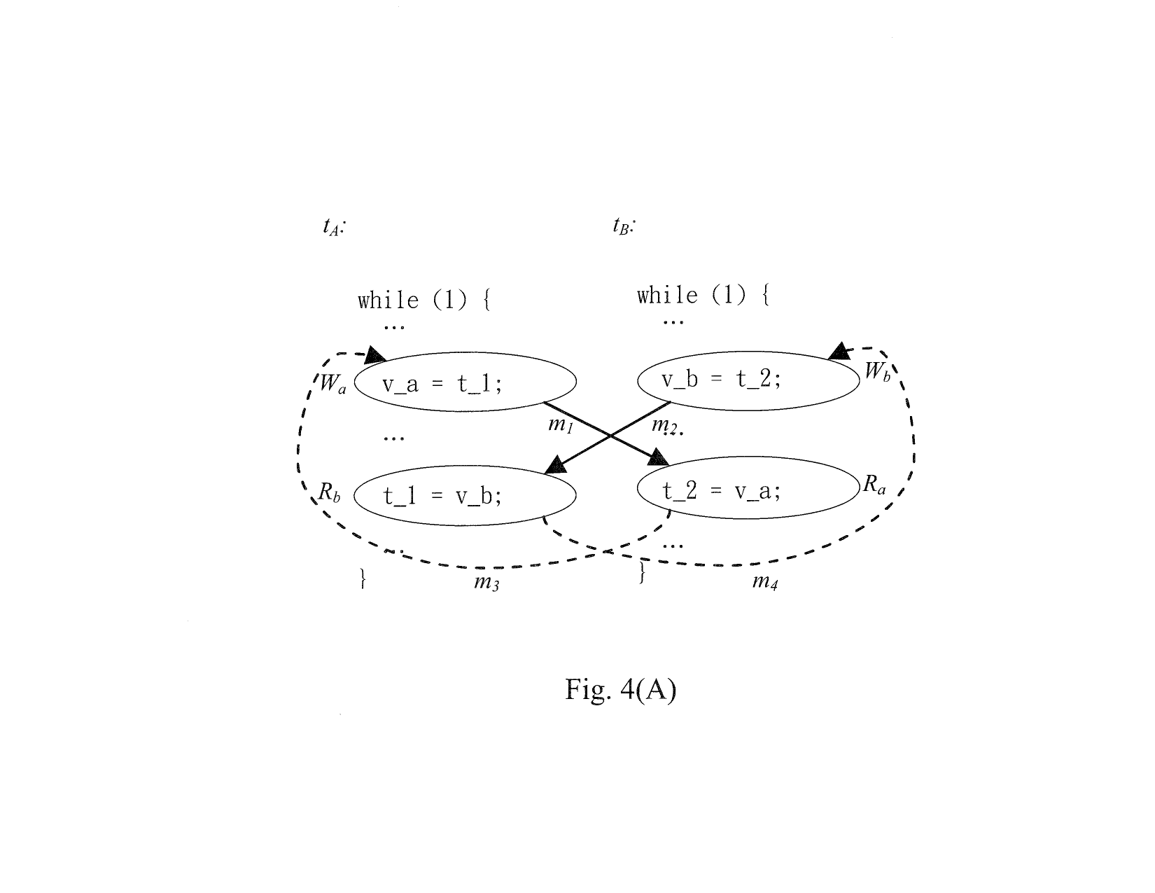

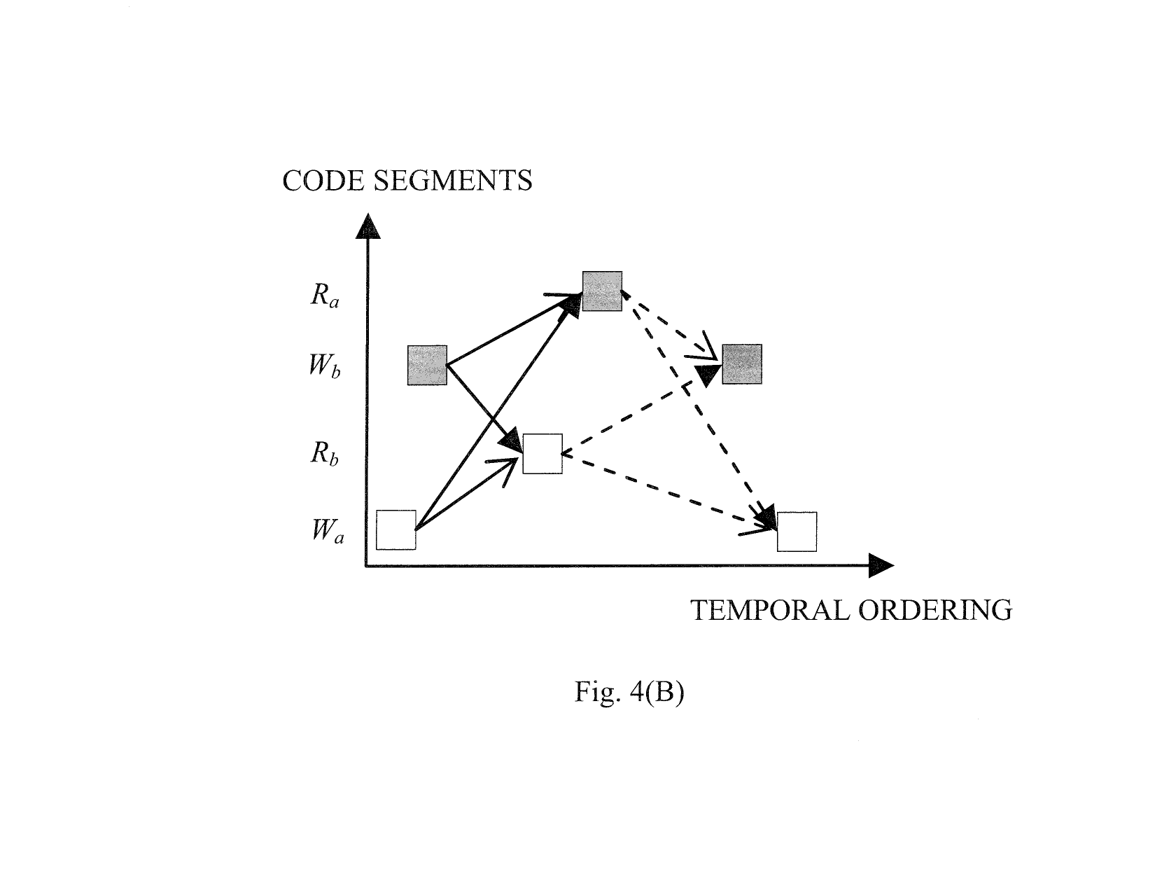

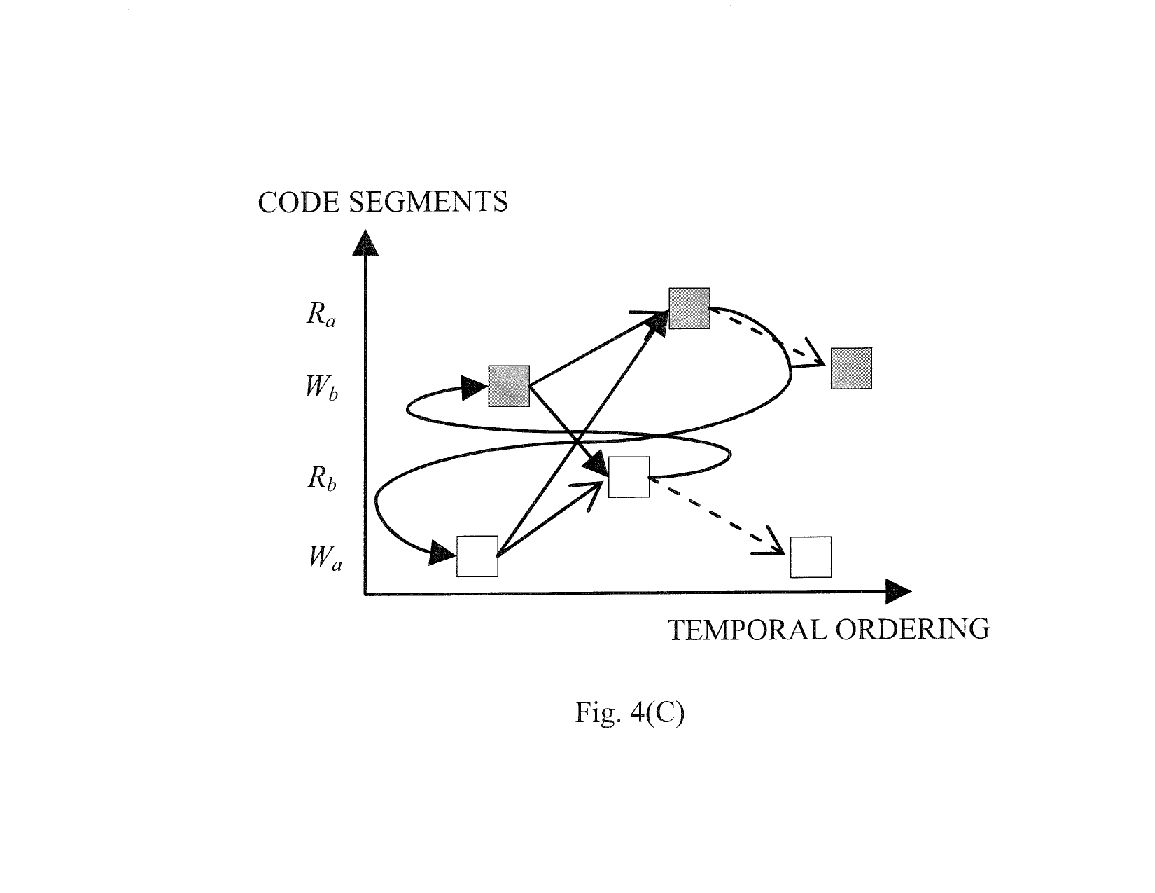

With reference to FIGS. 4A to 4C, t_{A} and t_{B} are threads of two parallel programs and exchange a first information (v_a) and a second information (v_b) in an infinite loop. The solid arrow indicates the normal must-happen-before relations and the dashed arrow indicates the loop-backed must-happen-before relations. The light color code segments are executed by thread (t_{A}) and the dark color code segments are executed by thread (t_{B}).

Let that the thread (t_{A}) writes the first information (v_a) to be the first code segment (Wₐ), and that the thread (t_{A}) reads the second information (v_b) to be the second code segment (R_{b}). Let that the thread (t_{B}) writes the second information (v_b) to be the third code segment (W_{b}), and that the thread (t_{B}) reads the first information (v_a) to be the fourth code segment (Rₐ).

To keep the information intact, execution of the fourth code segment (Rₐ) will be initiated only after the execution of the first code segment (Wₐ) is finished. The aforementioned relation is referred as a normal must-happen-before relation (m₁). Execution of the second code segment (R_{b}) will be initiated only after the execution of the third code segment (W_{b}) is finished. The aforementioned relation is referred as a normal must-happen-before relation (m₂).

The first code segment (Wₐ) will not be initiated until the execution of the fourth program (Rₐ) is over and the relation is referred as a loop-backed must-happen-before relation (m₃). Execution of the third code segment (W_{b}) will not be initiated until the execution of the second code segment (R_{b}) is finished and the relation is referred as a loop-backed must-happen-before relation (m₄).

From the showing of FIG. 4C, it is noted that the method of the present invention detects the existence of directed loops composed only by normal must-happen-before relations in the parallel programs so as to effectively avoid occurrence of a deadlock.

By using the given must-happen-before relations, a deadlock is identified. Otherwise, a practice code is synthesized with low level synchronization basic structure to solve issues in the parallel programs.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A deadlock free synchronization synthesizer for must-happen-before relations in at least two parallel programs or at least two threads each having multiple code segments, the synthesizer comprising:
an input device to specify a synchronization point for each code segment involved and must-happen-before relations to the synchronization point;
an analyzing module connected to the input device to detect an existence of a deadlock in the at least two parallel programs by using the must-happen-before relation; and
a synthesizing module connected to the analyzing module to synthesize a practice code corresponding to the at least two parallel programs if the deadlock existence detection is negative.

2. The synthesizer as claimed in claim 1, wherein in a must-happen-before relation, the code segments which must be executed first during run time are refereed as source code segments, and the other code segments are referred as destination code segments.

3. The synthesizer as claimed in claim 2, wherein the must-happen-before relations of the synchronization points are normal must-happen-before relations if the source code segments' first appearance is earlier than those of the destination code segments, and the must-happen-before relations of the synchronization points are loop-backed must-happen-before relations if the source code segments' first appearance is later than those of the destination code segments.

4. The synthesizer as claimed in claim 3, wherein the analyzing module establishes a schematic chart for the must-happen-before relations of the at least two parallel programs or the at least two threads to search for existence of a directed loop only having the normal must-happen-before relations in the must-happen-before relations of the parallel programs, if such directed loop having only the normal must-happen-before relations exists in the must-happen-before relations of the parallel programs, the judgment of a deadlock is affirmative, and if such directed loop having only the normal must-happen-before relations does not exist in the must-happen-before relations of the parallel programs, the judgment of the deadlock is negative.

5. The synthesizer as claimed in claim 4, wherein the synthesizing module is a low level synchronization basic structure.

6. A deadlock free method for must-happen-before relations in at least two parallel programs or at least two threads each having multiple code segments, the method comprising the steps of:
specifying a synchronization point to each involving code segment of the parallel programs or of the threads;
specifying must-happen-before relations to the synchronization point;
using the must-happen-before relations of the synchronization point to detect existence of deadlock in each of the parallel programs or threads based on;
judging existence of deadlock in the parallel programs; and
synthesizing a practice code corresponding to the parallel programs should the judgment of the existence of deadlock being negative.

7. The method as claimed in claim 6, wherein in a must-happen-before relation, the code segments which must be executed first during run time are refereed as source code segments, and the other code segments are referred as destination code segments.

8. The method as claimed in claim 7, wherein the must-happen-before relations of the synchronization points are normal must-happen-before relations if the source code segments' first appearance is earlier than those of the destination code segments, and the must-happen-before relations of the synchronization points are loop-backed must-happen-before relations if the source code segments' first appearance is later than those of the destination code segments.

9. The method as claimed in claim 8, wherein the deadlock existence judgment step further comprises the steps of:
establishing a schematic chart for the must-happen-before relations of the parallel programs,
examining the schematic chart to search for the existence of a directed loop in the normal must-happen-before relations included in the must-happen-before relations of the parallel programs,
so that if such directed loop having only the normal must-happen-before relations exists in the must-happen-before relations of the at least two parallel programs, the judgment of a deadlock is affirmative, and
if such directed loop having only the normal must-happen-before relations does not exist in the must-happen-before relations of the at least two parallel programs, the judgment of the deadlock is negative.

10. The method as claimed in claim 9, wherein a low level synchronization basic structure is employed to synthesize the practice code corresponding to the parallel programs.
